(19) United States
(12) Patent Application Publication
(10) Pub. No.: US 2010/0236652 A1
(43) Pub. Date: Sep. 23, 2010

(54) VALVE UNIT

(75) Inventor: Masakazu HATTORI, Gifu (JP)

Correspondence Address: OSHA LIANG L.L.P., TWO HOUSTON CENTER, 909 FANNIN, SUITE 3500, HOUSTON, TX, 77010, US

(73) Assignee: NABTESCO CORPORATION, Tokyo (JP)

(21) Appl. No.: 12/725,161

(22) Filed: Mar. 16, 2010

(30) Foreign Application Priority Data
Mar. 18, 2009 (JP) 2009-065544

(51) Int. Cl. F16K 11/00

(52) U.S. Cl. 137/625.42

(57) ABSTRACT

A valve unit 1 includes a first valve body 14 which is slidable in a valve housing 11 and a second valve body 13 which is slidable with respect to the first valve body 14, and the valve housing 11 has a first passage 11a and a second passage 11b in both of which pressure fluid flows to slide the second valve body 13, a pump port 11c, a tank port 11e, a first cylinder port 11d, and a second cylinder port 11f. A first state 1a, a third state 1c, a second state 1b, and a fourth state 1d are realized by a combination of a position of the first valve body 14 after sliding and a position of the second valve body 13 after sliding with respect to the first valve body 14.

### CROSS REFERENCE TO RELATED APPLICATION

The present application claims priority from Japanese Patent Application No. 2009-65544, which was filed on Mar. 18, 2009, the disclosure of which is herein incorporated by reference in its entirety.

### BACKGROUND OF THE INVENTION

The present invention relates to a valve unit, and particularly relates to a valve unit which changes the direction of fluid flow, prohibits fluid flow, and allows fluid flow, by switching the position of a valve body in a valve housing.

Such a technology is recited in, for example, Japanese Unexamined Patent Publication No. 303642/2007 (Tokukai 2007-303642). A valve unit recited in this document is arranged so that a first valve body (24) and a second valve body (26) are disposed in a single valve housing, in a slidable manner. By selecting a combination of a position of the first valve body (24) and a position of the second valve body (26) with respect to the first valve body (24) after these bodies are slid, it is possible to change the direction of fluid flow, prohibit fluid flow, and allow fluid flow. This technology recited in the patent document 1 makes it possible to obtain a small-sized, lightweight valve unit.

The valve unit of Japanese Unexamined Patent Publication No. 303642/2007, however, is arranged so that the second valve body (26) is slid by an electric motor attached to the edge of the valve unit. This electric motor requires a relatively large space in the valve unit, and increases the weight of the valve unit. Furthermore, the overall power consumption is high because the second valve body (26) is electrically driven.

### SUMMARY OF THE INVENTION

The present invention was done to solve the problems above, and an objective of the present invention is to provide a small-sized, lightweight valve unit of low power consumption.

To achieve the objective above, the present invention provides a valve unit comprising: a valve housing; a first valve body disposed in the valve housing in a slidable manner; and a second valve body disposed to be slidable with respect to the first valve body. The valve housing includes: a first passage and a second passage in which pressure fluid flows to slide the second valve body; a pump port connected to a pump; a tank port connected to a tank; and a first cylinder port and a second cylinder port both connected to a cylinder of a hydraulic actuator. A combination of a position of the first valve body after sliding and a position of the second valve body after sliding with respect to the first valve body achieves: a first state in which the pump port is connected to the first cylinder port whereas the second cylinder port is connected to the tank port; a second state in which the pump port is connected to the second cylinder port whereas the first cylinder port is connected to the tank port; a third state in which the pump port, the tank port, the first cylinder port, and the second cylinder port are closed; and a fourth state in which the pump port is closed whereas the first cylinder port is connected to the second cylinder port.

According to this arrangement, the second valve body is slid by the pressure fluid. The valve unit of the present invention does not therefore require an electric motor, and hence this valve unit is small in size, lightweight, and consumes a small amount of power, as compared to the conventional valve units.

The present invention is preferably arranged so that the position of the second valve body is controlled based on a position signal supplied from a feedback spring, a part of the feedback spring being provided in the valve housing.

This arrangement further ensures the downsizing of the valve unit.

In addition to the above, the present invention is preferably arranged so that the first valve body is disposed to be slidable with respect to an inner surface of the second valve body, and the first valve body is provided at its end portion with a first spring which biases the first valve body.

According to this arrangement, the first spring makes it possible to assuredly slide the first valve body, and in another aspect, the first valve body is fixedly provided around the center of the valve unit.

In addition to the above, the present invention is preferably arranged so that the first valve body is disposed to be slidable with respect to an outer surface of the second valve body, the first valve body is provided at its end portion with a first spring which biases the first valve body, and the second valve body is provided at its respective end portions with a second spring and a third spring both of which bias the second valve body.

According to this arrangement, the first spring makes it possible to assuredly slide the first valve body, and in another aspect, the first valve body is fixedly provided around the center of the valve unit. Furthermore, the second spring and the third spring allow the second valve body to smoothly move, and in another aspect, the second valve body is fixedly provided around the center of the valve unit.

The valve unit according to the present invention is suitable for controlling airplane control surfaces such as flaps, ailerons, elevators, and rudders.

### BRIEF DESCRIPTION OF THE DRAWINGS

FIG. 1 is a circuit diagram showing a hydraulic circuit in which a valve unit of First Embodiment according to the present invention is incorporated.

FIG. 2 shows the structure of the valve unit of FIG. 1.

FIG. 3A is a cross section for explaining the operation of the valve unit of FIG. 2.

FIG. 3B is a cross section for explaining the operation of the valve unit of FIG. 2.

FIG. 3C is a cross section for explaining the operation of the valve unit of FIG. 2.

FIG. 3D is a cross section for explaining the operation of the valve unit of FIG. 2.

FIG. 4 is a circuit diagram of a hydraulic circuit in which a valve unit of Second Embodiment according to the present invention is incorporated.

FIG. 5 shows the structure of the valve unit of FIG. 4.

FIG. 6A is a cross section for explaining the operation of the valve unit of FIG. 5.

FIG. 6B is a cross section for explaining the operation of the valve unit of FIG. 5.

FIG. 6C is a cross section for explaining the operation of the valve unit of FIG. 5.

FIG. 6D is a cross section for explaining the operation of the valve unit of FIG. 5.

### DESCRIPTION OF THE PREFERRED EMBODIMENTS

The following will describe an embodiment of the present invention with reference to figures. An airplane is provided on its wings with plural moving parts (airplane control surfaces) for changing the flight attitude, the direction of flight, and receiving lift forces. Examples of such moving parts (airplane control surfaces) include flaps, ailerons, elevators, and rudders. The valve unit according to the present invention is suitable for controlling these moving parts (airplane control surfaces).

### First Embodiment

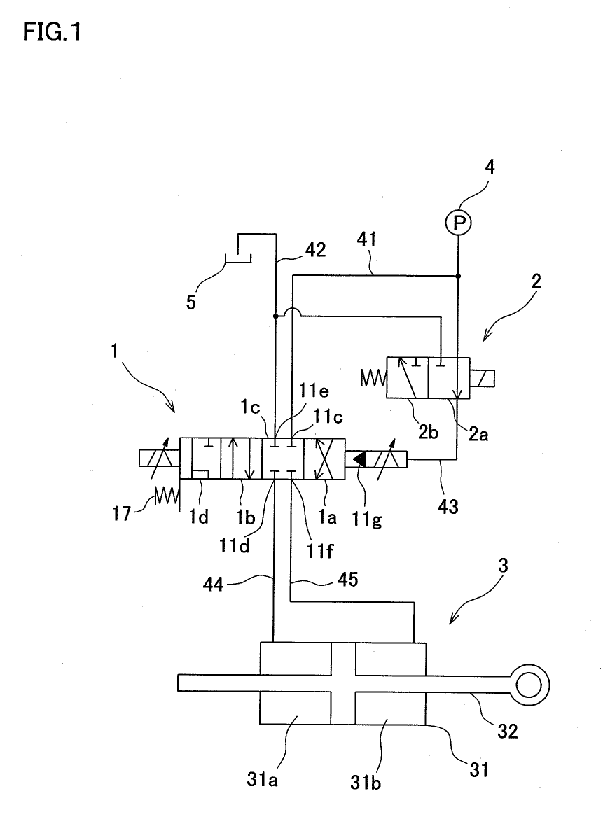

FIG. 1 is a circuit diagram of a hydraulic circuit in which a valve unit 1 of First Embodiment according to the present invention is incorporated.

The hydraulic circuit shown in FIG. 1 includes a pump 4 (hydraulic pump), a hydraulic actuator 3, a valve unit 1, a pilot valve 2, and a tank 5. The pump 4 ad the valve unit 1 are connected to each other by a hydraulic supply passage 41. The tank 5 and the valve unit 1 are connected to each other by a drain passage 42. The valve unit 1 and the hydraulic actuator 3 are connected to each other by a first cylinder passage 44 and a second cylinder passage 45. The valve unit 1 and the pilot valve 2 are connected to each other by a pilot passage 43.

(Valve Unit)

As shown in FIG. 1, the valve unit 1 has a pump port 11c and a tank port 11e. The valve unit 1 is connected to the pump 4 at the pump port 11c via the hydraulic supply passage 41, and is also connected to the tank 5 at the tank port 11e via the drain passage 42. The valve unit 1 has a first cylinder port 11d and a second cylinder port 11f. The valve unit 1 is, at the first cylinder port 11d and the second cylinder port 11f, connected to the hydraulic actuator 3 via the first cylinder passage 44 and the second cylinder passage 45, respectively.

The valve unit 1 is a four position valve having a first state 1a, a second state 1b, a third state 1c, and a fourth state 1d. The first state 1a through the third state 1c are provided for a normal mode whereas the fourth state 1d is provided for a bypass mode.

In the first state 1a, the pump port 11c is connected to the first cylinder port 11d whereas the second cylinder port 11f is connected to the tank port 11e. In the second state 1b, the pump port 11c is connected to the second cylinder port 11f whereas the first cylinder port 11d is connected to the tank port 11e. In the third state 1c, the pump port 11c, the tank port 11e, the first cylinder port 11d, and the second cylinder port 11f are closed (mutually blocked).

In the fourth state 1d, the pump port 11c is closed whereas the first cylinder port 11d is connected to the second cylinder port 11f. In the present embodiment, the first cylinder port 11d, the second cylinder port 11f, and the tank port 11e are connected to one another in the fourth state 1d. The fourth state 1d may be alternatively arranged so that the first cylinder port 11d and the second cylinder port 11f are not connected to the tank port 11e (i.e. the tank port 11e is closed).

(Structure of Valve Unit)

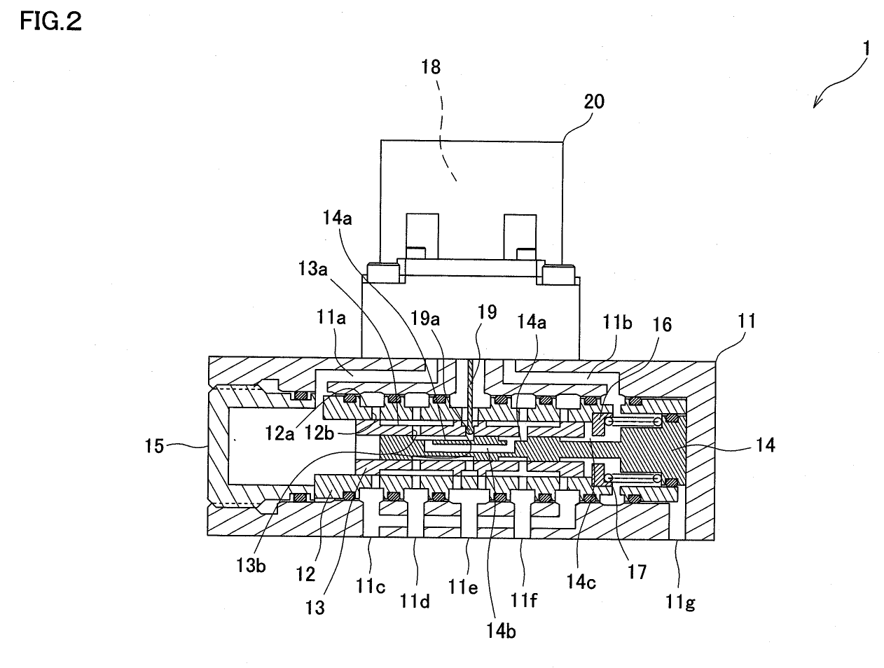

FIG. 2 shows the structure of the valve unit 1 of FIG. 1. It is noted that the same reference numerals are assigned to components having substantially identical arrangements as those of FIG. 1. The valve unit 1 shown in FIG. 2 is in the fourth state 1d (bypass mode). As shown in FIG. 2, the valve unit 1 is provided with a valve housing 11 and a casing 20 attached to one surface of the valve housing 11.

(Valve Housing)

Inside the valve housing 11, a first passage 11a and a second passage 11b are formed on the casing 20 side to allow pressure fluid for sliding a later-described second valve body 13 to flow therein. On another surface of the valve housing 11 are formed the pump port 11c connected to the pump 4, the tank port 11e connected to the tank 5, the first cylinder port 11d and the second cylinder port 11f connected to a cylinder 31 of the hydraulic actuator 3, and a pilot port 11g connected to the pilot valve 2.

The valve housing 11 stores therein components such as an outer sleeve 12, a second valve body 13, and a first valve body 14.

The valve housing 11 is sealed by screwing a cap 15 into one end of the housing 11. The outer shape of the valve housing 11 is rectangular parallelepiped, for example.

(Second Valve Body)

To the inner surface of the valve housing 11, a tubular outer sleeve 12 is fixed. On the outer surface of the outer sleeve 12 are formed plural (6 in the present embodiment) ring-shaped circumferential grooves 12a. The space inside the outer sleeve 12 is connected to the grooves 12a via passages 12b formed in the outer sleeve 12.

The outer sleeve 12 houses therein a tubular second valve body 13 to be slidable with respect to the inner surface of the outer sleeve 12. On the outer surface of the second valve body 13, plural ring-shaped circumferential grooves 13a are formed. (In the present embodiment, two wide grooves and one narrow groove are formed.) The space inside the second valve body 13 is connected to the grooves 13a by passages 13b formed in the second valve body 13.

(First Valve Body)

The second valve body 13 houses therein a stick-shaped first valve body 14 to be slidable with respect to the inner surface of the second valve body 13. On one side of the first valve body 14, plural (two in the present embodiment) ring-shaped circumferential grooves 14a are formed on the outer surface. These two grooves 14a are connected to each other by a passage 14b formed in the first valve body 14.

On the other end of the first valve body 14, a first spring 17 (coil spring) is provided to bias the first valve body 14 in an axial direction. Between the first spring 17 and the second valve body 13, a ring-shaped collar 16 is inserted. This collar 16 has a notch (which is not illustrated; i.e. slit). By this notch, the second passage 11b is connected to the passage 14c inside the collar 16.

(Casing)

The casing 20 houses therein an electromagnetic mechanism 18. This electromagnetic mechanism 18 has a flapper (not illustrated), and a stick-shaped feedback spring 19 is attached to the leading end of the flapper. The feedback spring 19 has a spheric portion 19a at the leading end and this spheric portion 19 is housed in the passage 13b of the second valve body 13. The width of the passage 13b is substantially equal to the external diameter of the spheric portion 19a. The feedback spring 19 is provided for detecting the position of the second valve body 13. As the spheric portion 19a at the leading end of the feedback spring 19 moves with the second valve body 13, it is possible to precisely detect the position of the second valve body 13. The position of the second valve body 13 is controlled based on a position signal from the feedback spring 19. In consideration of downsizing and structural simplification of the valve unit 1, the feedback spring 19 is preferred as in the present embodiment: however, the position of the second valve body 13 may be detected by position detection means such as a differential transformer.

(Hydraulic Actuator)

Turning back to FIG. 1, the hydraulic actuator 3 has a cylinder 31 and a piston rod 32. The piston rod 32 is moved by pressure fluid which is ejected to a first cylinder chamber 31a and a second cylinder chamber 31b from the pump 4 via the valve unit 1. The piston rod 32 is connected to, at its leading end, an airplane control surface (not illustrated) which is a flap, an aileron or the like of the airplane.

(Pilot Valve)

The pilot valve 2 is a solenoid valve for switching the valve unit 1 to the states (first state 1a through third state 1c) of the normal mode and the state (fourth state 1d) of the bypass mode. As the pilot valve 2 is electromagnetically operated, the pilot valve 2 is switched to the connection state 2a, so that a pilot pressure is introduced into the valve unit 1 via the pilot port 11g. With this, the valve unit 1 is switched to the normal mode. On the other hand, when the valve unit 1 is to be switched to the bypass mode, the pilot valve 2 is switched to the cutoff state 2b by instructing the pilot valve 2 to stop the electromagnetic force. The valve unit 1 is also switched to the bypass mode because the pilot pressure is lost, when the pump 4 is broken down for some reason.

(Operation of Valve Unit)

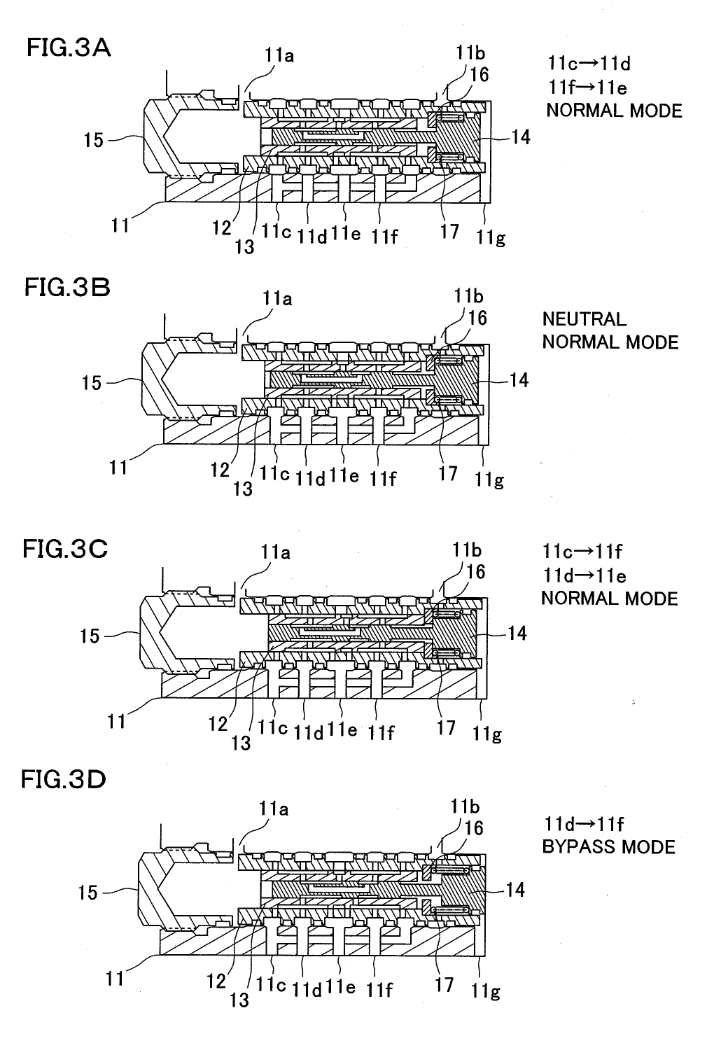

Now, the operation of the valve unit 1 will be described with reference to FIGS. 1-3. FIG. 3A through FIG. 3D are cross sections for describing the operation of the valve unit 1. FIG. 3A, FIG. 3B, FIG. 3C, and FIG. 3D show the first state 1a, the third state 1c, the second state 1b, and the fourth state 1d of the valve unit 1, respectively. It is noted that the same reference numerals are assigned to components having substantially identical arrangements as those of FIG. 2.

(Bypass Mode)

When the pilot valve 2 does not produce an electromagnetic force or when the pump 4 is broken down, no pilot pressure is introduced into the valve unit 1 via the pilot port 11g. In this case, the first valve body 14 is on the right side of the figure on account of the biasing force of the first spring 17 (i.e. the first valve body 14 is at a standstill as the end face of the first valve body 14 is in contact with the inner wall of the valve housing 11). With this, as shown in FIG. 3D, the fourth state 1d is reached so that the pump port 11c is closed while the first cylinder port 11d, the second cylinder port 11f, and the tank port 11e are connected to one another. As the first cylinder port 11d is connected to the second cylinder port 11f, the piston rod 32 of the hydraulic actuator 3 becomes movable by an external force (not illustrated).

As discussed above, the valve unit 1 shown in FIG. 2 is in the fourth state 1d (bypass mode). Although FIG. 2 shows that as if the passage 13b is closed by the spheric portion 19a at the leading end of the feedback spring 19, in reality the passage 13b is not closed by the spheric portion 19a. For example, the width of the passage 13b in the direction orthogonal to the figure is longer than the external diameter of the spheric portion 19a, and hence pressure fluid can flow in the passage 13b even if the spheric portion 19a is provided therein.

(Normal Mode)

(Forward Movement of Piston Rod)

As the pilot valve 2 produces an electromagnetic force, the first spring 17 contracts on account of a pilot pressure introduced into the valve unit 1 via the pilot port 11g, and hence the first valve body 14 is slid toward the left side of the figure (i.e. the first valve body 14 is standstill as it is in contact with the collar 16). In this state, the electromagnetic mechanism 18 having the flapper is operated to increase the fluid pressure P2 of the second passage 11b to be higher than the fluid pressure P1 of the first passage 11a. As a result, the second valve body 13 is slid toward the left side of the figure. The position where the second valve body 13 stops is determined based on the position signal for the second valve body 13, which is supplied from the feedback spring 19. More specifically, based on the position signal supplied from the feedback spring 19, the electromagnetic mechanism 18 moves the flapper to cause the fluid pressures P1 and P2 to be equal to each other (i.e. to balance the fluid pressure P1 with the fluid pressure P2) when the second valve body 13 reaches a predetermined position, so that the movement of the second valve body 13 is stopped (the same applies to stopping and backward movement of the piston rod 32, both of which will be described later). It is noted that details of the electromagnetic mechanism 18 having the flapper are shown in Japanese Unexamined Patent Publication No. 64702/1992 (Tokukai 4-64702).

As a result of the above, as shown in FIG. 3A, the first state 1a is reached so that the pump port 11c is connected to the first cylinder port 11d whereas the second cylinder port 11f is connected to the tank port 11e. In this state, the pressure fluid from the pump 4 is introduced into the first cylinder chamber 31a of the cylinder 31 via the valve unit 1, the pressure fluid in the second cylinder chamber 31b returns to the tank 5 via the valve unit 1, and the piston rod 32 carries out the forward movement. The moving speed of the piston rod 32 is determined in accordance with a stop position (position after the sliding) of the second valve body 13 (the same applies to the later-described backward movement of the piston rod 32). Furthermore, although the supply passages are not illustrated, pressure fluid is supplied from the pump 4 to the first passage 11a and the second passage 11b via the flapper.

(Stopping of Piston Rod)

The electromagnetic mechanism 18 is operated while the pilot valve 2 produces an electromagnetic force, so that the fluid pressure P2 of the second passage 11b is arranged to be lower than the fluid pressure P1 of the first passage 11a. With this, the second valve body 13 is slid toward the right side of the figure. Thereafter, as shown in FIG. 3B, the second valve body 13 is stopped, when the third state 1c is reached so that the pump port 11c, the tank port 11e, the first cylinder port 11d, and the second cylinder port 11f are closed (mutually blocked). Eventually, the piston rod 32 is stopped and this stopped state is maintained.

(Backward Movement of Piston Rod)

The electromagnetic mechanism 18 is operated while the pilot valve 2 produces an electromagnetic force, so that the fluid pressure P2 of the second passage 11b is arranged to be lower than the fluid pressure P1 of the first passage 11a. With this, the second valve body 13 is slid toward the right side of the figure. Thereafter, as shown in FIG. 3C, the second state 1b is reached so that the pump port 11c is connected to the second cylinder port 11f whereas the first cylinder port 11d is connected to the tank port 11e. In this state, the pressure fluid from the pump 4 is introduced into the second cylinder chamber 31b of the cylinder 31 via the valve unit 1, the pressure fluid in the first cylinder chamber 31a returns to the tank 5 via the valve unit 1, and the piston rod 32 carries out the backward movement.

As discussed above, the valve unit 1 of the present embodiment is arranged so that one of the first state 1a, the third state 1c, the second state 1b, and the fourth state 1d is reached according to a combination of a position of the first valve body 14 after the sliding and a position of the second valve body 13 after the sliding with respect to the first valve body 14. As previously described, both of the first valve body 14 and the second valve body 13 are slid by pressure fluid. The valve unit 1 does not require an electric motor for this reason, and it is therefore possible to provide a valve unit 1 which is smaller in size, lighter in weight, and consumers less power than conventional valve units. Furthermore, the first valve body 14 is assuredly slid by the first spring 17. In another aspect, the first valve body 14 is fixedly provided around the center of the valve unit 1 by the first spring 17. Since the first valve body 14 is fixedly provided around the center, the shift to each mode (first state 1a through third state 1c) is easily done when recovering from the loss of fluid pressure (breakdown of the pump 4) (i.e. when the pump 4 is back to normal).

### Second Embodiment

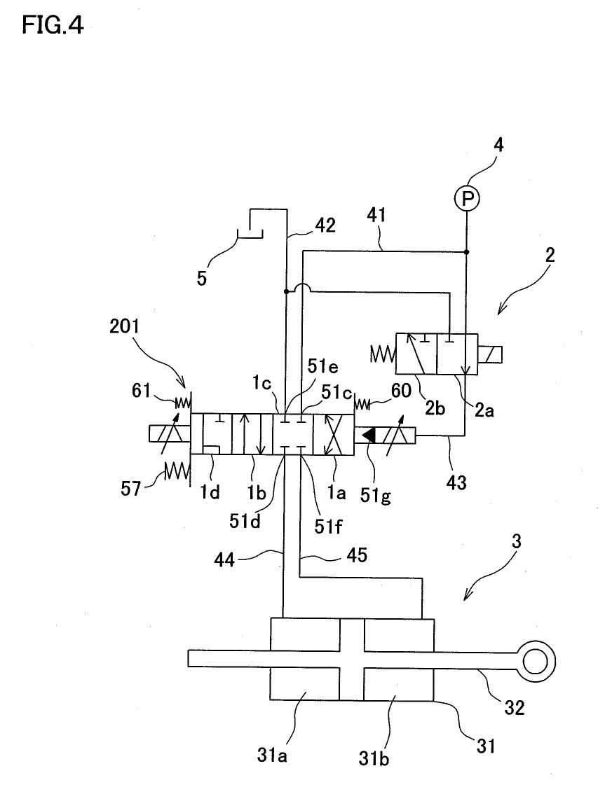

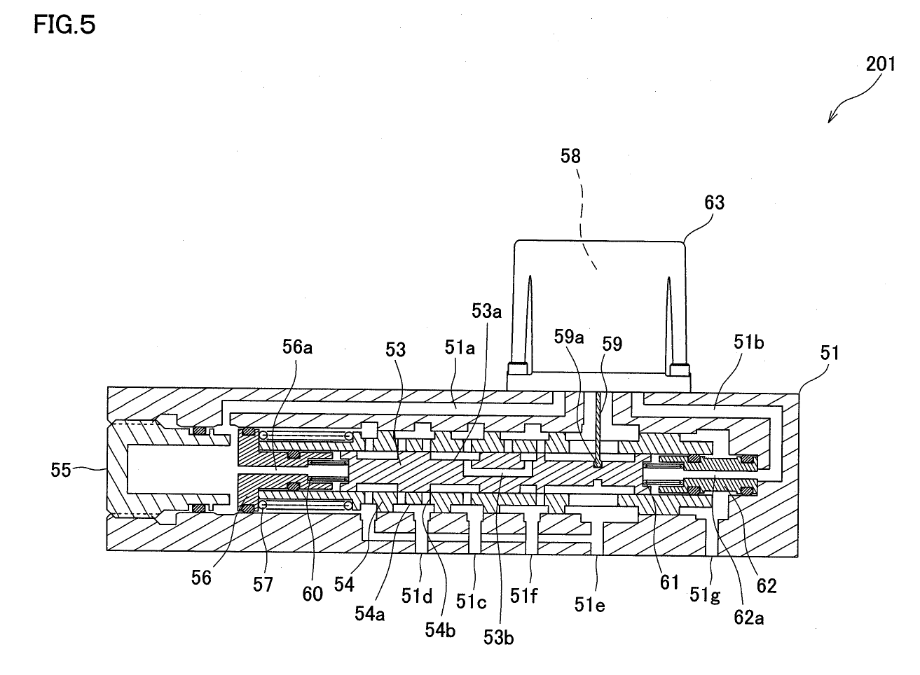

FIG. 4 is a circuit diagram showing a hydraulic circuit in which a valve unit 201 of Second Embodiment according to the present invention is incorporated. FIG. 5 shows the structure of the valve unit 201 shown in FIG. 4. In FIG. 4, the same reference numerals are assigned to components having substantially identical arrangements as those of FIG. 1. The valve unit 201 shown in FIG. 5 is in the third state 1c (i.e. the neutral state in the normal mode). The present embodiment will be described focusing on the differences from First Embodiment.

A major difference between the valve unit 201 of the present embodiment and the valve unit 1 of First Embodiment lies in that, in the present embodiment, the second valve body 53 is provided at its end portions with a second spring 60 and a third spring 61 which bias a second valve body 53.

First of all, the valve housing 11, the cap 15, the first passage 11a, the second passage 11b, the pump port 11c, the first cylinder port 11d, the tank port 11e, the second cylinder port 11f, the pilot port 11g, the first spring 17, the casing 20, the electromagnetic mechanism 18, and the feedback spring 19 (including the spheric portion 19a) of First Embodiment are respectively identical with a valve housing 51, a cap 55, a first passage 51a, a second passage 51b, a pump port 51c, a first cylinder port 51d, a tank port 51e, a second cylinder port 51f, a pilot port 51g, a first spring 57, a casing 63, an electromagnetic mechanism 58, and a feedback spring 59 (including a spheric portion 59a) of Second Embodiment.

(First Valve Body)

The valve housing 51 houses therein a tubular first valve body 54 to be slidable with respect to the inner surface of the valve housing 51. The first valve body 54 is provided on its outer surface with plural ring-shaped circumferential grooves 54a. The space inside the first valve body 54 is connected to the grooves 54a via passages 54b formed in the first valve body 54. Furthermore, the first valve body 54 is provided at its one end portion with a first spring 57 (coil spring) which biases the first valve body 54 in an axial direction. The edge of this first spring 57 is in contact with a tubular member 56 which is disposed on one-end side of the first valve body 54 and has a passage 56a at its center.

(Second Valve Body)

In the present embodiment, the first valve body 54 houses therein a stick-shaped second valve body 53 to be slidable with respect to the inner surface of the first valve body 54. The second valve body 53 is provided on its outer surface with plural ring-shaped circumferential grooves 53a. Among these grooves 53a, the central two grooves 53a are connected with each other by a passage 53b formed in the second valve body 53.

(Second Spring)

The second spring 60 (coil spring) is disposed between the second valve body 53 and the tubular member 56 which are disposed to form a straight line. This second spring 60 biases the second valve body 53 in an axial direction.

(Third Spring)

A tubular member 62 having a passage 62a at its center is provided so that the second valve body 53 is sandwiched between the tubular member 62 and the second spring 60. Between the second valve body 53 and the tubular member 62 which form a straight line, a third spring 61 (coil spring) is disposed. This third spring 61 biases the second valve body 53 in an axial direction opposite to the direction of the biasing force of the second spring 60. The biasing force of the second spring 60 is equal to the biasing force of the third spring 61.

(Operation of Valve Unit)

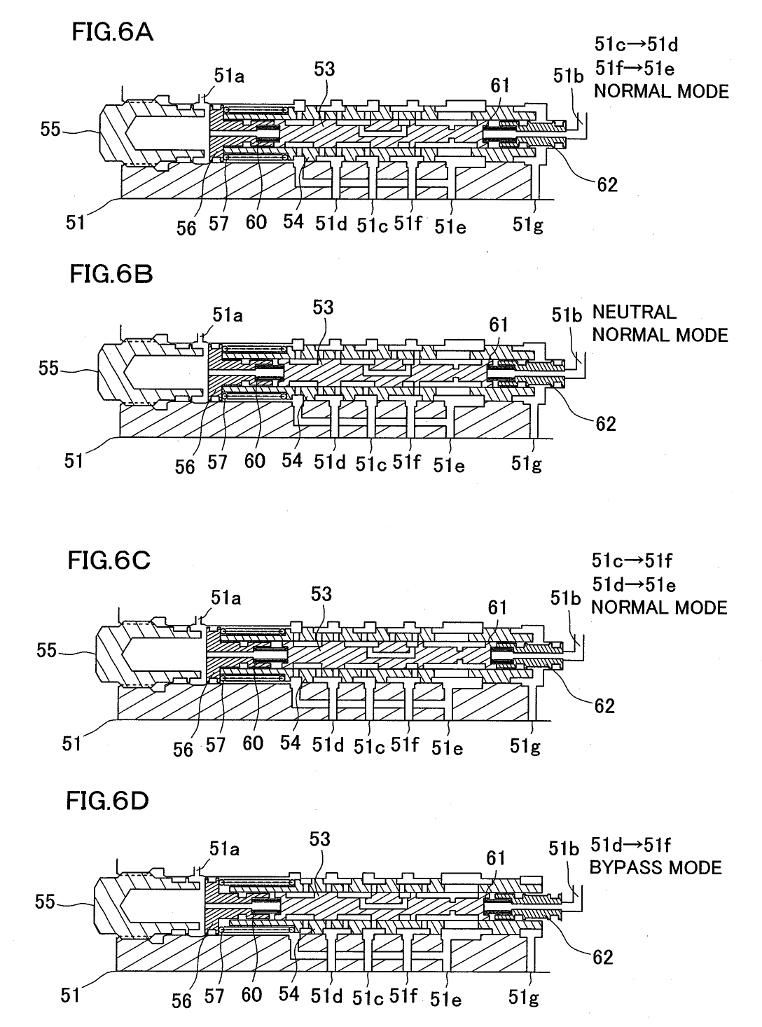

Now, the operation of the valve unit 201 will be described. FIG. 6A through FIG. 6D are cross sections for describing the operation of the valve unit 201 shown in FIG. 5. FIG. 6A, FIG. 6B, FIG. 6C, and FIG. 6D show a first state 1a, a third state 1c, a second state 1b, and a fourth state 1d of the valve unit 201, respectively. It is noted that the same reference numerals are assigned to components having substantially identical arrangements as those of FIG. 5.

(Bypass Mode)

When the pilot valve 2 does not produce an electromagnetic force or when the pump 4 is broken down, no pilot pressure is introduced into the valve unit 201 via the pilot port 51g. In this case, the first valve body 54 is in the right side of the figure on account of the biasing force of the first spring 57 (i.e. the first valve body 14 is at a standstill as the end face of the first valve body 54 is in contact with the inner wall of the valve housing 51). With this, as shown in FIG. 6D, the fourth state 1d is reached so that the pump port 51c is closed while the first cylinder port 51d, the second cylinder port 51f, and the tank port 51e are connected to one another. As the first cylinder port 51d is connected to the second cylinder port 51f, the piston rod 32 of the hydraulic actuator 3 becomes movable by an external force (not illustrated).

(Normal Mode)

(Forward Movement of Piston Rod)

As the pilot valve 2 produces an electromagnetic force, the first spring 57 contracts on account of a pilot pressure introduced into the valve unit 201 via the pilot port 51g, and hence the first valve body 54 is slid toward the left side of the figure (i.e. the first valve body 54 is standstill as it is in contact with the tubular member 56). In this state, the electromagnetic mechanism 58 having the flapper is operated to increase the fluid pressure P2 of the second passage 51b to be higher than the fluid pressure P1 of the first passage 51a. As a result, the second valve body 53 is slid toward the left side of the figure.

As a result, as shown in FIG. 6A, the first state 1a is reached so that the pump port 51c is connected to the first cylinder port 51d whereas the second cylinder port 51f is connected to the tank port 51e. In this state, the pressure fluid from the pump 4 is introduced into the first cylinder chamber 31a of the cylinder 31 via the valve unit 201, the pressure fluid in the second cylinder chamber 31b returns to the tank 5 via the valve unit 201, and the piston rod 32 carries out the forward movement. The moving speed of the piston rod 32 is determined in accordance with a stop position (position after the sliding) of the second valve body 53 (the same applies to the later-described backward movement of the piston rod 32).

(Stopping of Piston Rod)

The electromagnetic mechanism 58 is operated while the pilot valve 2 produces an electromagnetic force, so that the fluid pressure P2 of the second passage 51b is arranged to be lower than the fluid pressure P1 of the first passage 51a. With this, the second valve body 53 is slid toward the right side of the figure. Thereafter, as shown in FIG. 6B, the second valve body 53 is stopped, when the third state 1c is reached so that the pump port 51c, the tank port 51e, the first cylinder port 51d, and the second cylinder port 51f are closed (mutually blocked). Eventually, the piston rod 32 is stopped and this stopped state is maintained.

(Backward Movement of Piston Rod)

The electromagnetic mechanism 58 is operated while the pilot valve 2 produces an electromagnetic force, so that the fluid pressure P2 of the second passage 51b is arranged to be lower than the fluid pressure P1 of the first passage 51a. With this, the second valve body 53 is slid toward the right side of the figure. Thereafter, as shown in FIG. 6C, the second state 1b is reached so that the pump port 51c is connected to the second cylinder port 51f whereas the first cylinder port 51d is connected to the tank port 51e. In this state, the pressure fluid from the pump 4 is introduced into the second cylinder chamber 31b of the cylinder 31 via the valve unit 1, the pressure fluid in the first cylinder chamber 31a returns to the tank 5 via the valve unit 1, and the piston rod 32 carries out the backward movement.

As described above, the valve unit 201 of the present embodiment is advantageous in that, since the second spring 60 and the third spring 61 are provided at the both ends of the second valve body 53, sudden changes in the fluid pressures P1 and P2 do not result in an undesirable quick action of the second valve body 53 because the second spring 60 and the third spring 61 function as cushioning members. In other words, the second valve body 53 moves smoothly, and hence the piston rod 32 moves smoothly. In another aspect, since the second spring 60 and the third spring 61 are disposed at the both ends of the second valve body 53, the second valve body 53 can be fixedly provided around the center of the valve unit 201 by a simple structure and without increasing the weight. With this, the shift to each mode (first state 1a through third state 1c) is easily done when recovering from the loss of fluid pressure (breakdown of the pump 4) (i.e. when the pump 4 is back to normal).

While this invention has been described in conjunction with the specific embodiments outlined above, it is evident that many alternatives, modifications and variations will be apparent to those skilled in the art.

What is claimed is:

1. A valve unit comprising:
a valve housing;
a first valve body disposed in the valve housing in a slidable manner; and
a second valve body disposed to be slidable with respect to the first valve body,
wherein, the valve housing includes:
a first passage and a second passage in which pressure fluid flows to slide the second valve body;
a pump port connected to a pump;
a tank port connected to a tank; and
a first cylinder port and a second cylinder port both connected to a cylinder of a hydraulic actuator,
and wherein, a combination of a position of the first valve body after sliding and a position of the second valve body after sliding with respect to the first valve body achieves:
a first state in which the pump port is connected to the first cylinder port whereas the second cylinder port is connected to the tank port;
a second state in which the pump port is connected to the second cylinder port whereas the first cylinder port is connected to the tank port;
a third state in which the pump port, the tank port, the first cylinder port, and the second cylinder port are closed; and
a fourth state in which the pump port is closed whereas the first cylinder port is connected to the second cylinder port.

2. The valve unit according to claim 1, wherein,
the position of the second valve body is controlled based on a position signal supplied from a feedback spring, a part of the feedback spring being provided in the valve housing.

3. The valve unit according to claim 1, wherein,
the first valve body is disposed to be slidable with respect to an inner surface of the second valve body, and
the first valve body is provided at its end portion with a first spring which biases the first valve body.

4. The valve unit according to claim 1, wherein,
the first valve body is disposed to be slidable with respect to an outer surface of the second valve body,
the first valve body is provided at its end portion with a first spring which biases the first valve body, and
the second valve body is provided at its respective end portions with a second spring and a third spring both of which bias the second valve body.

5. The valve unit according to claim 1, wherein,
an airplane control surface is attached to a leading end of a piston rod of the hydraulic actuator.
